(19) United States
(12) Patent Application Publication
(10) Pub. No.: US 2008/0038050 A1
(43) Pub. Date: Feb. 14, 2008

(54) ROTARY MECHANISMS

(75) Inventors: Chien Hung Chen, Taipei County (TW); Hsin Hung Lin, Taoyuan County (TW); Chia Hung Lin, Taipei City (TW); Wen Ken Wang, Taipei County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/734,719

(22) Filed: Apr. 12, 2007

(30) Foreign Application Priority Data
Apr. 14, 2006 (TW) 95113323

(51) Int. Cl. F16D 1/12

(52) U.S. Cl. 403/62; 248/276.1

(57) ABSTRACT

Rotary mechanisms are provided. A rotary mechanism comprises a first member, a second member rotatable with respect to the first member along a first axis, and a first washer fixed to the first member. The first washer comprises a plurality of protrusions projecting toward the second member. The second washer is fixed to the second member and comprises a plurality of sliding surfaces, a plurality of depressions respectively disposed between the sliding surfaces, and a plurality of openings formed on the sliding surfaces. The protrusions are joined in the openings when the second member rotates to an angle with respect to the first member.

### BACKGROUND OF THE INVENTION

1. Field of the Invention

The invention relates in general to rotary mechanisms and in particular to rotary mechanisms capable of angle positioning.

2. Description of the Related Art

A conventional flat display is rotatably connected to a support in three-dimensional space. However, due to the lack of positioning mechanisms, angle positioning of the flat display can be difficult. Moreover, rotary mechanisms of the support may fatigue with excessive rotation of the flat display, adversely affecting safety and utility thereof.

### BRIEF SUMMARY OF THE INVENTION

Rotary mechanisms are provided. A rotary mechanism comprises a first member, a second member rotatable with respect to the first member along a first axis, and a first washer fixed to the first member. The first washer comprises a plurality of protrusions projecting toward the second member. The second washer is fixed to the second member and comprises a plurality of sliding surfaces, a plurality of depressions respectively disposed between the sliding surfaces, and a plurality of openings formed on the sliding surfaces. The protrusions are joined in the openings when the second member rotates to an angle with respect to the first member.

### BRIEF DESCRIPTION OF THE DRAWINGS

The invention can be more fully understood by reading the subsequent detailed description and examples with references made to the accompanying drawings, wherein:

FIG. 1 is an exploded diagram of a rotary mechanism;

FIG. 2 is an enlarged view of portion A in FIG. 1;

FIG. 3A is a perspective diagram of a first washer;

FIG. 3B is a side view of the first washer in FIG. 3A;

FIG. 4A is a perspective diagram of a second washer;

FIG. 4B is a side view of the second washer in FIG. 4A;

FIG. 4C is a top view of the second washer in FIG. 4A;

FIGS. 5 and 6 are perspective diagrams of a first member and a third member pivotally connected by fasteners;

FIG. 7 is a perspective diagram of a first member rotating to a first angle; and

FIG. 8 is a perspective diagram of a first member rotating to a second angle.

### DETAILED DESCRIPTION OF THE INVENTION

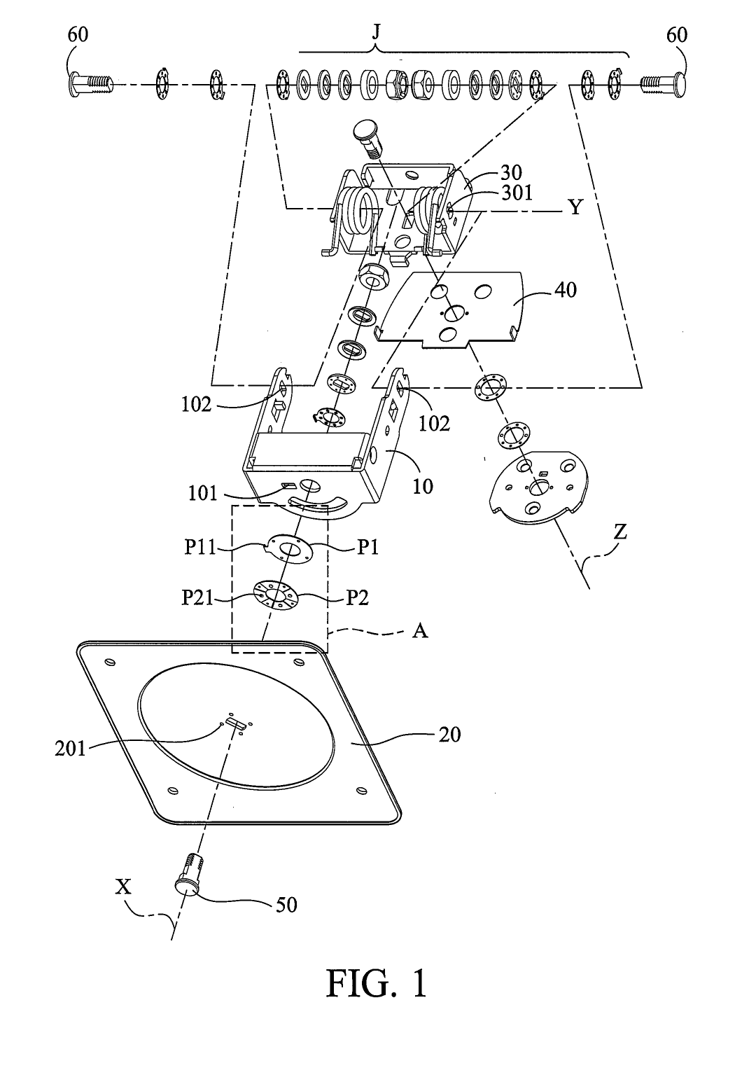

Referring to FIG. 1, an embodiment of a rotary mechanism, such as a support for a flat display, comprises a first member 10, a second member 20, a third member 30, and fourth member 40. As shown in FIG. 1, the second member 20 is rotatable with respect to the first member 10 around a first axis (X axis), the first member 10 is rotatable with respect to the third member 30 around a second axis (Y axis), and the third member 30 is rotatable with respect to the fourth member 40 around a third axis (Z axis). In this embodiment, the fourth member 40 is fixed to a base or a supporting surface, and the flat display (not shown) is mounted on the second member 20 and rotatable around X, Y, and Z axes.

As shown in FIG. 1, a first washer P1 and a second washer P2 are disposed between the first and second members 10 and 20. The first washer P1 comprises a hook P11 joined to a first hole 101 of the first member 10, and the second washer P2 comprises a plurality of nubs P21 joined to the second holes 201 of the second member 20.

In FIG. 1, a fastener 50 is sequentially inserted through the second member 20, the second washer P2, the first washer P1, and the first member 10 along X axis. When the second member 20 rotates relative to the first member 10, the first washer P1 slides on the second member 20. Specifically, when the first member 10 is at a specific angle relative to the second member 20, the first and second washers P1 and P2 are joined, to hold the first and second members 10 and 20 at the specific angle.

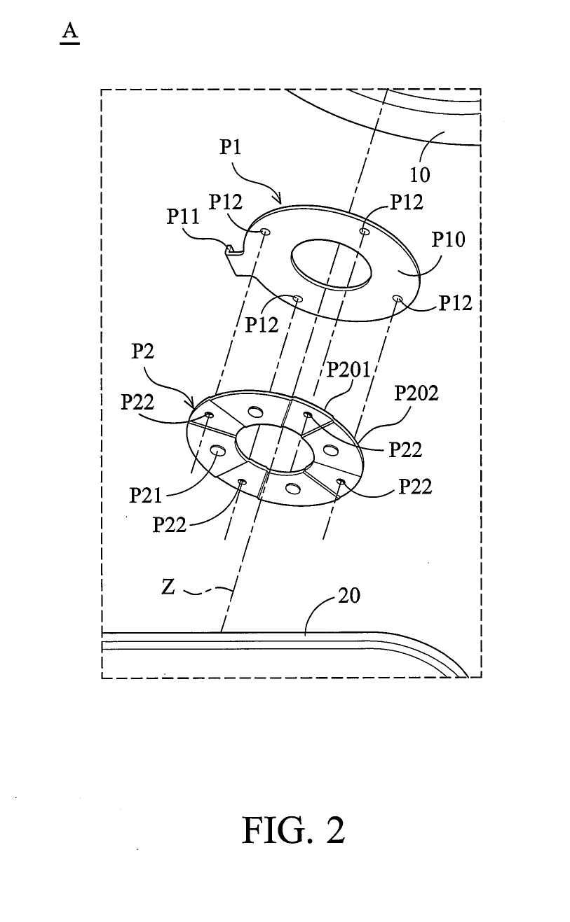

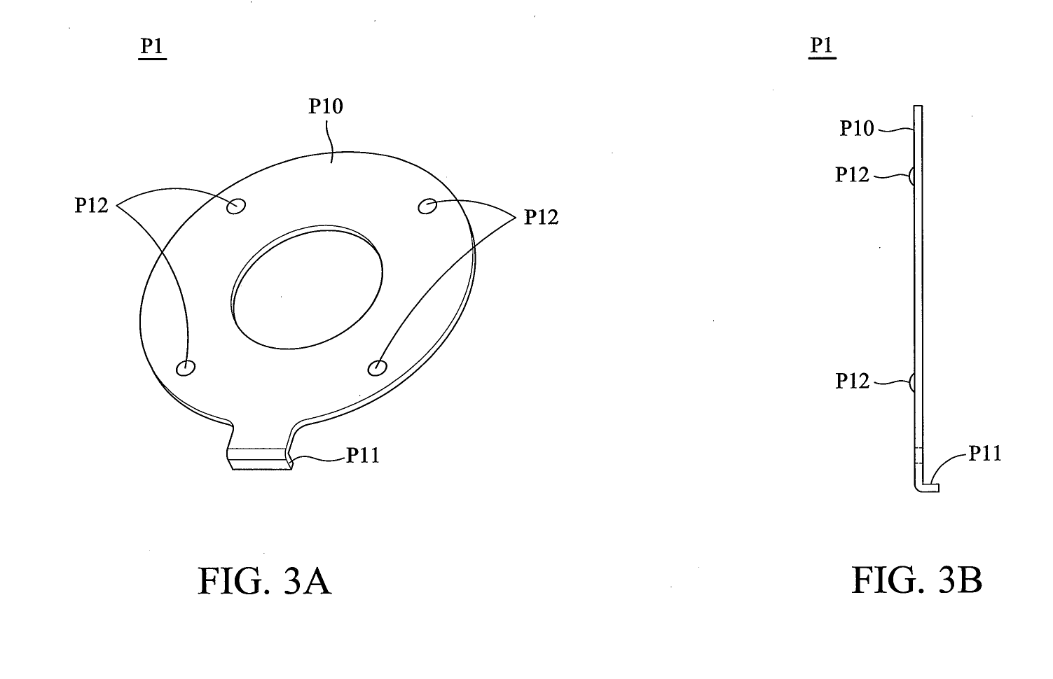

As shown in FIGS. 2, 3A and 3B, the first washer P1 comprises a plurality of protrusions P12 on a side P10 thereof, and correspondingly, the second washer P2 comprises a plurality of openings P22 with the protrusions P12 joined therein when the second member 20 is at the specific angle relative to the first member 10.

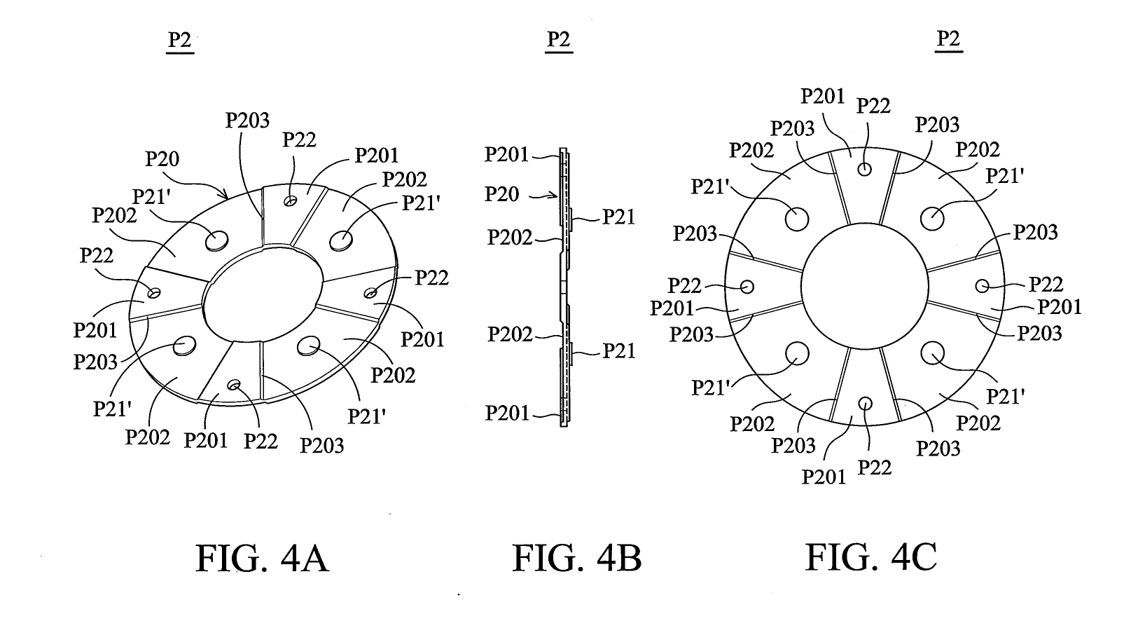

Referring to FIGS. 2, 4A-4C, the second washer P2 comprises a plurality of sliding surfaces P201 and a plurality of depressions P202 therebetween. Here, a plurality of openings P22 are respectively formed on the sliding surfaces P201, and each of the depressions P202 forms a recess P21′ on the rear of the nubs P21. In this embodiment, the sliding surfaces P201, the depressions P202, the openings P22, and the recesses P21′ are symmetrical to X axis.

During rotation of the first and second members 10 and 20, the protrusions P12 of the first washer P1 slides through the sliding surfaces P201 and the depressions P202 around X axis. Since distance from the depressions P202 to the first washer P1 exceeds that from the sliding surfaces P201 to the first washer P1, friction between the protrusions P12 and the sliding surfaces P201 exceeds that between the protrusions P12 and the depressions P202. As shown in FIG. 4C, the sliding surfaces P201 and the depressions P202 are connected via slopes P203, capable of better tactile feedback during rotation of the first and second members 10 and 20.

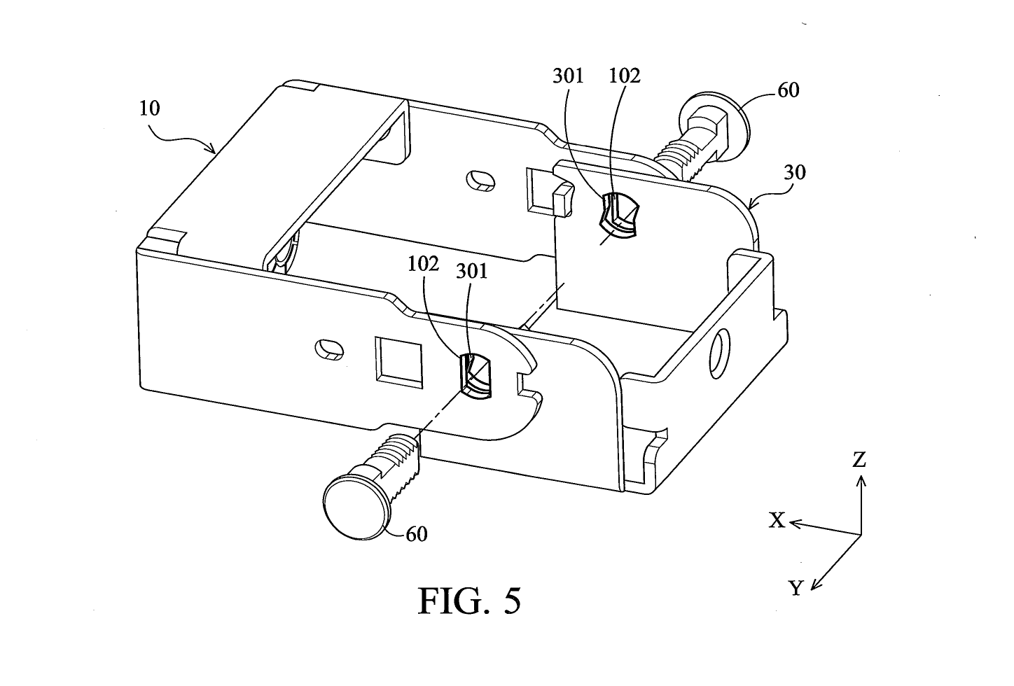

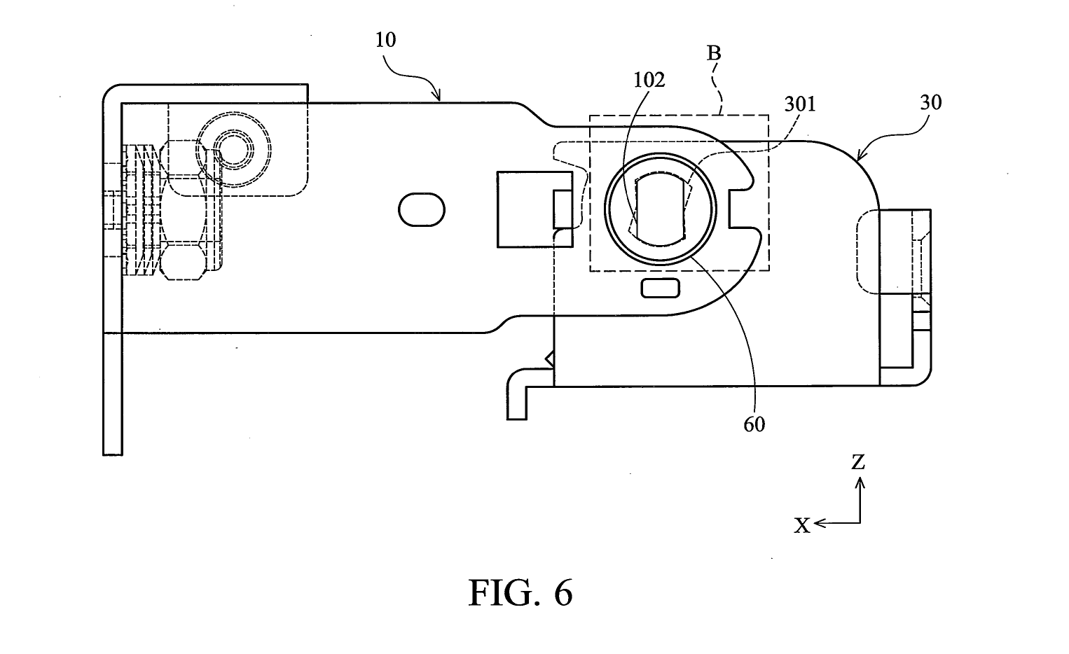

FIGS. 5 and 6 are perspective diagrams of the first and third members 10 and 30 pivotally connected by fasteners 60 of FIG. 1. It is noted that the parts set J of FIG. 1 is omitted from FIGS. 5 and 6 to clearly depict the rotary mechanism of the first and third members 10 and 30. Here, the first member 10 is rotatable with respect to third member 30 around Y axis, wherein the first member 10 comprises a first through hole 102, and the third member 30 comprises a second through hole 301 corresponding thereto. During assembly, the fastener 60 is fitted in the first through hole 102 and inserted through the second through hole 301.

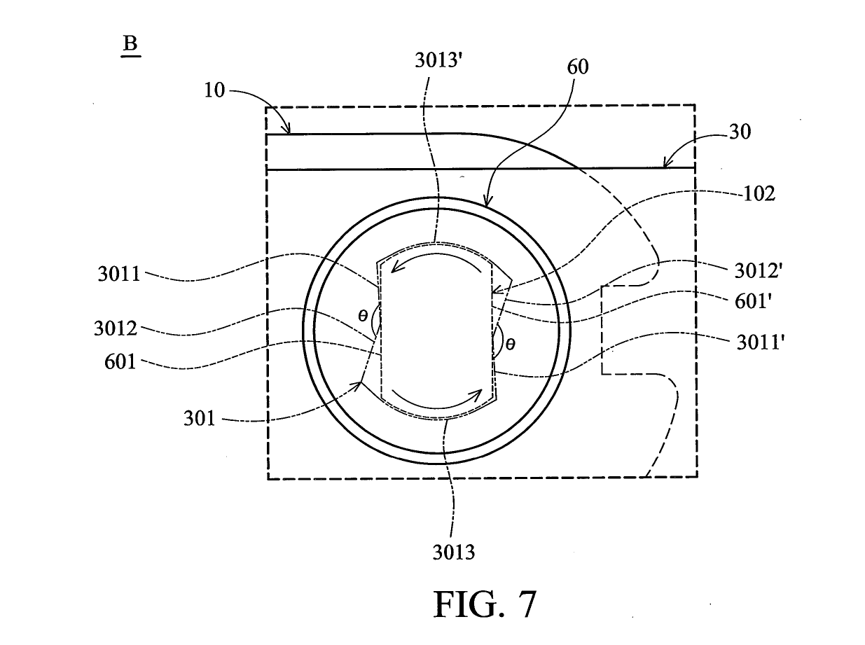

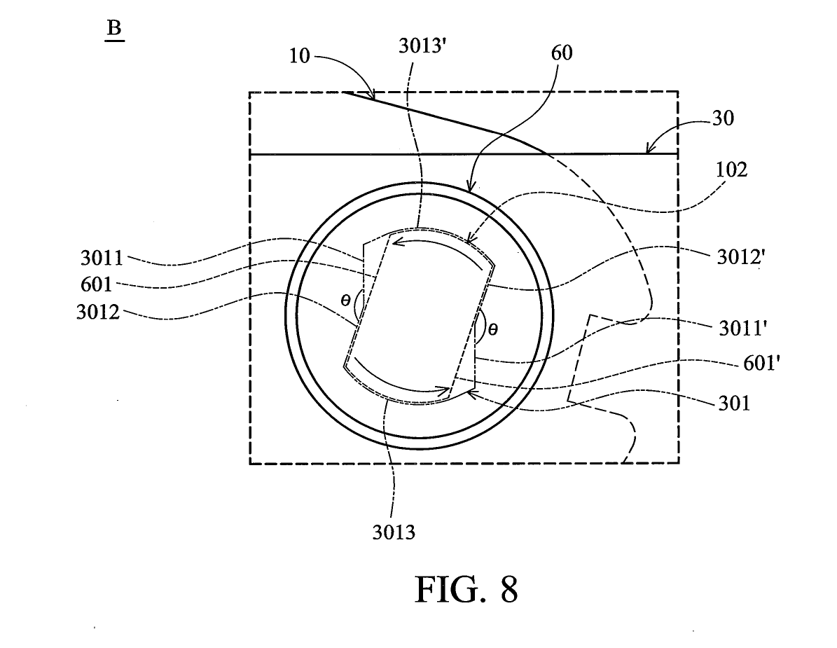

As shown in FIG. 7, the second through hole 301 is substantially 8-shaped and larger than the first through hole 102. The second through hole 301 has two parallel first walls 3011, 3011′, and two parallel second walls 3012 and 3012′. In this embodiment, the first walls 3011, 3011′ and the second walls 3012 and 3012′ form an angle θ, wherein 0°<θ<180°. The fastener 60 has two parallel contact surfaces 601 and 601′ respectively abutting the first walls 3011 and 3011′ of the second through hole 301 when the first member 10 rotates counterclockwise to a first angle with respect to the third member 30, as shown in FIG. 7, to restrict the first member 10 at the first angle. When the first member 10 rotates clockwise to a second angle with respect to the third member. 30, as shown in FIG. 8, the contact surfaces 601 and 601′ of the fastener 60 respectively abut the second walls 3012 and 3012′ of the second through hole 301, to restrict the first member 10 at the second angle.

In FIGS. 7 and 8, the second through hole 301 further has two curved surfaces 3013 and 3013′ connecting the first walls 3011, 3011′ and the second walls 3012 and 3012′. During rotation of the first and third members 10 and 30, the fastener 60 slides on the curved surfaces 3013 and 3013′, wherein rotation between the first and third members 10 and 30 is restricted between the first and second angles by the second through hole 301 in 8-shaped profile.

Rotary mechanisms are provided according to the embodiments. The rotary mechanism, such as a support of a flat display, is easy to assemble and facilitates angle positioning, improving safety and convenience thereof.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A rotary mechanism, comprising:
a first member;
a second member, rotatable with respect to the first member along a first axis;
a first washer fixed to the first member, comprising a plurality of protrusions projecting toward the second member; and
a second washer fixed to the second member; comprising a plurality of sliding surfaces, a plurality of depressions respectively disposed between the sliding surfaces, and a plurality of openings formed on the sliding surfaces, wherein the protrusions are joined in the openings when the second member rotates to an angle with respect to the first member.

2. The rotary mechanism as claimed in claim 1, wherein the first member comprises a first hole, and the first washer further comprises a hook joined threrein.

3. The rotary mechanism as claimed in claim 1, wherein the first washer comprises four protrusions symmetric to the first axis, and the second washer comprises four sliding surfaces and depressions symmetric to the first axis.

4. The rotary mechanism as claimed in claim 1, wherein distance from the depressions to the first washer exceeds that from the sliding surfaces to the first washer.

5. The rotary mechanism as claimed in claim 1, wherein the second washer further comprises a plurality of slopes connecting the sliding surfaces and the depressions.

6. The rotary mechanism as claimed in claim 1, wherein the second washer further comprises a plurality of nubs, and the second member comprises a plurality of second holes with the nubs joined therein.

7. The rotary mechanism as claimed in claim 1, further comprising a third member, wherein the first member is rotatable with respect to the third member along a second axis, substantially perpendicular to the first axis.

8. The rotary mechanism as claimed in claim 1, further comprising a fourth member, wherein the third member is rotatable with respect to the fourth member along a third axis, substantially perpendicular to the first and second axes.

9. A support for a flat display, comprising a rotary mechanism as claimed in claim 1.

10. A rotary mechanism, comprising:
a first member, comprising a first through hole;
a third member, rotatable with respect to the first member along a second axis, comprising a second through hole, wherein the second through hole is substantially 8-shaped and comprises two parallel first walls and two parallel second walls forming an included angle θ (0°<θ<180°); and
a fastener, fitted in the first through hole and through the second through hole, wherein the fastener comprises two contact surfaces abutting the first walls when the first member rotates to a first angle with respect to the third member, and the contact surfaces abut the second walls when the first member rotates to a second angle with respect to the third member, whereby the first member is restricted between the first and second angles.

11. The rotary mechanism as claimed in claim 10, wherein the second through hole is larger than the first through hole.

12. The rotary mechanism as claimed in claim 10, wherein the second through hole further comprises two curved surfaces connecting the first and second walls, and the fastener slides on the curved surfaces during rotation of the first and third members.

13. The rotary mechanism as claimed in claim 10, further comprising a second member rotatable with respect to the first member along a first axis, substantially perpendicular to the second axis.

14. The rotary mechanism as claimed in claim 10, further comprising a fourth member, wherein the third member is rotatable with respect to the fourth member along a third axis, substantially perpendicular to the first and second axes.

15. A support for a flat display, comprising a rotary mechanism as claimed in claim 10.
